(19) United States
(12) Patent Application Publication
(10) Pub. No.: US 2026/0335929 A1
(43) Pub. Date: Oct. 29, 2026

(54) METHOD TO MINIMIZE OVERLAP VISIBILITY IN DROP-ON-DEMAND COATING APPLICATIONS

(71) Applicant: AXALTA COATING SYSTEMS IP CO., LLC, Wilmington, DE (US)

(72) Inventors: Jonathan Alexander Antal, Philadelphia, PA (US); Michael S. Wolfe, Wilmington, DE (US); Cameron Lee Stevens, Philadelphia, PA (US); Austin Boyd, Media, PA (US)

(73) Assignee: AXALTA COATING SYSTEMS IP CO., LLC, Wilmington, DE (US)

(21) Appl. No.: 19/548,238

(22) Filed: Feb. 24, 2026

Related U.S. Application Data
(60) Provisional application No. 63/793,215, filed on Apr. 23, 2025.

(51) Int. Cl. B05D 1/26

(52) U.S. Cl. CPC B05D 1/26

(57) ABSTRACT

A method for minimizing overlap visibility in drop-on-demand coating application, the method includes the steps of applying at least two overlapping swathes of a coating material onto a surface of a substrate to achieve a target dry film thickness, creating a density gradient to generate a transition zone, and controlling a slope of the transition zone to a value of less than about 0.45 microns per millimeter, to minimize overlap visibility.

### CROSS-REFERENCE TO RELATED APPLICATIONS

This application claims the benefit of U.S. Provisional Application No. 63/793,215, filed on, Apr. 23, 2025, the disclosure of which is expressly incorporated by reference herein.

### TECHNICAL FIELD

The present disclosure generally relates to a method for minimizing overlap visibility in drop-on-demand coating applications. More specifically, the method includes applying a coating material onto a surface of a substrate in a particular manner to create a transition zone and controlling a slope of the transition zone to a value of less than about 0.45 microns per millimeter, to minimize overlap visibility.

### BACKGROUND

Drop-on-Demand (DOD) printing is widely used in various industrial applications, including packaging, textiles, printed electronics, automotive coating, etc. This technique generally relies on precise ejection of droplets of coating materials, e.g. paint, ink, coating compositions, etc., from nozzles of a DOD applicator to a surface of a substrate, enabling high-resolution and customizable printing.

Advances in DOD printing can increase interest in more complex printing applications, such as printing on a large object, printing on a three-dimensional object, printing on a complex substrate, printing a complicated pattern, etc. Previously, some of these complex applications have been performed using conventional techniques, such as spray painting, which can be environmentally undesirable and cost-prohibited due to the release of large numbers of excess particles of coating materials into the atmosphere. In contrast, using a DOD system may provide advantages due to its ability to print in a targeted and controlled manner, without releasing excess particles of coating materials into the environment. DOD printing may also reduce the usage of coating materials, thereby reducing the cost and material waste.

A disadvantage of using a DOD system for complex printing applications is that the coating material can experience flow before drying/curing, which can lead to a disparity between the desired location and/or film thickness of the coating material and its final dried location and/or film thickness.

These disadvantages may be observed in various applications. For example, when printing on a large surface, multiple swaths may be printed to cover the whole surface. DOD printheads may move back and forth in multiple passes. With each pass producing one print swath (strip) with each pass. In an ideal situation, two or more adjacent swaths would be constrained to the intended print region, i.e. where the droplets of the coating material are applied. In reality, the coating material may flow/migrate prior to the drying/curing such that the coating material extends beyond intended print regions, resulting in various surface defects, e.g. forming of a bulge on the surface, heterogenous thickness of the material, visible overlap defects, etc. The extent of the defects may be influenced by a number of factors, e.g. viscosity and drying time of the coating material, desired film thickness, etc. It may be generally understood that the effect may be observed when printing two or more swaths where a first swath is deposited adjacent to a second swath.

Various alternative techniques have been developed to attempt to overcome the above-described issues, e.g. by using materials that are fast-drying and/or fast-curable, applying multiple thin-printed layers, typically less than about 10 μm, that can dry quickly, etc. However, in applications where these alternative techniques cannot provide desirable features and/or cannot be utilized, overlap visibility defects remain a significant challenge. Accordingly, there is an opportunity for improvement.

### BRIEF SUMMARY

This disclosure provides a method for minimizing overlap visibility in drop-on-demand (DOD) coating applications. The method includes the step of applying at least two overlapping swaths of a coating material onto a surface of a substrate to achieve a target dry film thickness wherein each swath has an edge. The method further includes the step of creating a density gradient along the edge of at least one swath to generate a transition zone, wherein a width of the transition zone is proportionally adjusted based on the target dry film thickness to soften a visible transition between overlapping swaths. The method also includes the step of controlling a slope of the transition zone to a value of less than about 0.45 microns per millimeter, calculated by dividing a height of the transition zone by the width of the transition zone, to minimize overlap visibility.

The disclosure additionally provides a second method. The second method includes the step of applying two overlapping swaths of the coating material onto the surface of the substrate to achieve a target dry film thickness of from about 1 to about 100 microns.

The disclosure further provides a third method. The third method includes the step of applying two overlapping swaths of a waterborne coating composition onto the surface of the substrate to achieve a target dry film thickness of from about 1 to about 100 microns wherein each swath has an edge. This method further includes the step of controlling the slope of the transition zone to a value of from about 0.2 to about 0.4 microns per millimeter.

### BRIEF DESCRIPTION OF THE DRAWINGS

The present disclosure will hereinafter be described in conjunction with the following drawing figures, wherein like numerals denote like elements, and

FIG. 1 is a side view of a Drop-on-Demand applicator applying droplets of a coating material onto a surface of a substrate;

FIG. 2 is a top view photograph of two non-overlapping swaths of the coating material that have approximately the same density gradient;

FIG. 3A is a photograph of a substrate coated with a solvent-borne coating composition, i.e. Coating Composition 2 of the Examples, in a two-coat application process using a conventional method, where overlap visibility is observed;

FIG. 3B is a photograph of a substrate coated with a solvent-borne coating composition, Coating Composition 2 of the Examples, in a two-coat application process using the method disclosed herein, where overlap visibility is not observed;

FIG. 4 is a collection of illustrations of top and side views of four density gradients of 20%, 30%, 40% and 50% for rows A, B, C and D, respectively; at increasing target dry film thickness (top down), where material migration is not present; and

FIG. 5 is a collection of illustrations of top and side views of four density gradients 20%, 30%, 40% and 50% for rows A, B, C and D, respectively, at increasing target dry film thickness (top down), where material migration is present.

### DETAILED DESCRIPTION

The following detailed description is merely exemplary in nature and is not intended to limit the instant disclosure. Furthermore, there is no intention to be bound by any theory presented in the preceding background or the following detailed description.

In general, the present disclosure provides coating materials and methods of applying coating materials onto surfaces of substrates.

For the sake of brevity, well-known conventional techniques related to the coating materials, methods, processes, devices, systems, and articles, etc., as well as various portions and components thereof, may be introduced or otherwise set forth in the embodiments herein with varying levels of description. For example, conventional techniques related to formation of the coating materials may not be described in detail herein, as the various steps in the manufacture of such compositions are well-known and will be readily understood and envisaged by those of skill in the art in view of the embodiments and examples provided herein. Similarly, various tasks and process steps described herein may be incorporated into a more comprehensive procedure or process having additional steps or functionality not otherwise described, e.g. for being well-known and readily appreciated by those of skill in the art. Such conventional steps may only be mentioned briefly or may be omitted entirely without providing well-known process details.

In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values describe herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The coating materials/compositions and methods of application disclosed herein may suitably comprise, consist of, or consist essentially of the components, elements, and process delineations described herein. The embodiments illustratively disclosed herein suitably may be practiced in the absence of any element which is not specifically disclosed herein.

This disclosure provides a method for minimizing overlap visibility in drop-on-demand coating applications. The method may be further described as a method of applying a coating material/composition, method of minimizing a surface defect, a drop-on-demand (DOD) method, a printing method, etc. The method may be used to apply, print, deposit, and/or coat a surface of a substrate with a coating material, e.g. a paint, a basecoat, a topcoat, etc. The coating material may be further described as not an ink, or different from an ink. Furthermore, the method may be used to customize and/or develop a printing process.

The method includes the step of applying at least two overlapping swaths of a coating material onto a surface of a substrate to achieve a target dry film thickness wherein each swath has an edge. The method also includes the step of creating a density gradient along the edge of at least one swath to generate a transition zone, wherein a width of the transition zone is proportionally adjusted based on the target dry film thickness to soften a visible transition between overlapping swaths. The method further includes the step of controlling a slope of the transition zone to a value of less than about 0.45 microns per millimeter, calculated by dividing a height of the transition zone by the width of the transition zone, to minimize overlap visibility. The steps described herein may be performed in any order, as determined by the skilled person. One or more steps may be performed once or repeated, e.g. as deemed appropriate for different coating applications. Some or all of the steps may be performed sequentially and/or concurrently. Each of the steps may be performed using any tool, equipment, technique known in the art.

In various embodiments, the method includes the aforementioned steps, and the method may further include, or be free of, an additional step, e.g. adjusting the width of the transition zone, drying/curing the coating material, measuring thickness of the swath, etc.

In other embodiments, the method comprises the aforementioned steps, and the method may further include, or be free of, an additional step, e.g. adjusting the width of the transition zone, drying/curing the coating material, measuring thickness of the swath, etc.

In still other embodiments, the method consists of the aforementioned steps, and the method is free of an additional step, e.g. adjusting the width of the transition zone, drying/curing the coating material, measuring thickness of the swath, etc.

In various embodiments, the method consists essentially of the aforementioned steps, and the method may optionally include, or be free of, an additional step, e.g., adjusting the width of the transition zone, drying/curing the coating material, measuring thickness of the swath, etc., such that coating materials and articles formed therefrom exhibit the properties as described herein.

### Applying the Coating Material:

### Coating Material:

The method includes the step of applying at least two overlapping swaths of a coating material. The coating material is not particularly limited and may be any known in the art. The coating material may be described as a coat, a paint, a printing material, a composition, a coating composition, a printer fluid, etc. The coating material is not an ink and is different from an ink, as understood in the art. Alternatively, the coating material may be described in terms of its function in coating applications, e.g. a primer, a surfacer, a basecoat, a topcoat, a clearcoat, a color coat, etc. The coating material may be described in terms of its method of preparation. For example, the coating material may be described as a 1-component, i.e. 1K composition or 1-part composition, a 2-component, i.e. 2K composition or 2-part composition, a ready-to-use composition, a concentrate, a diluted composition, etc. The coating material may also be described in terms of components that it can include. In various embodiments, the coating material includes water and is further described as a waterborne coating composition. In other embodiments, the coating material includes a solvent and is further described as a solvent-borne coating composition.

The coating material may include various components. In various embodiments, the coating material is a waterborne coating composition and includes water. The water may be present in various amounts, typically from about 1 to about 99 wt %, based on a total weight of the waterborne coating composition. In various embodiments, the water is present in an amount of from about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55, wt % based on a total weight of the waterborne coating composition. In other embodiments, the water is present in an amount of from about 40 to about 90, about 45 to about 85, about 50 to about 80, about 55 to about 75, about 60 to about 70, or about 65 to about 70, wt %, based on a total weight of the waterborne coating composition. In various non-limiting embodiments, all values and ranges of values, both whole and fractional, including and between the aforementioned values, are hereby expressly contemplated for use herein. In various embodiments, the coating material is free of water.

The waterborne coating composition may include or be free of a solvent. The terminology “free of a solvent” may be used described an amount of less than about 5 wt % solvent, alternatively less than about 4, 3, 2, 1, wt % solvent, e.g. from about 0 and up to about 5, about 0.1 to about 4, about 0.2 to about 3, about 0.3 to about 2, about 0.4 to about 1, about 0.5 to about 1, wt %, based on a total weight of the waterborne coating composition. In various non-limiting embodiments, all values and ranges of values, both whole and fractional, including and between the aforementioned values, are hereby expressly contemplated for use herein.

In various embodiments, the coating material is a waterborne coating composition and includes water and a water-soluble cosolvent. The water-soluble cosolvent may be any known in the art. Non-limiting examples of water-soluble cosolvents include methanol, propanol, butanol, ethanol, 1,2-butanediol, 1,3-butanediol, 1,3-propanediol, 1,4-butanediol, 1,4-dioxane, 1,5-pentanediol, 2-butoxyethanol, 2-propanol, acetaldehyde, acetic acid, acetone, acetonitrile, butyric acid, diethanolamine, diethylenetriamine, dimethoxyethane, dimethyl sulfoxide, dimethylformamide, ethylamine, ethylene glycol, formic acid, furfuryl alcohol, glycerol, methyl diethanolamine, methyl isocyanide, n-methyl-2-pyrrolidone, propanoic acid, propylene glycol, pyridine, tetrahydrofuran, triethylene glycol, glycol ethers (ethylene glycol monobutyl ether, diethylene glycol monobutyl ether, etc., any and all isomers thereof, or combinations thereof. Alternatively, the waterborne coating composition may be free of any one or more of the aforementioned solvents.

In various embodiments, the water-soluble cosolvent is present in the waterborne coating composition in an amount of from 1 to about 99 wt %, based on a total weight of the coating material. In various embodiments, the amount of water-soluble co-solvent is present in an amount of from about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55, wt % based on a total weight of the waterborne coating composition. In other embodiments, the water-soluble cosolvent is present in an amount of from about 40 to about 90, about 45 to about 85, about 50 to about 80, about 55 to about 75, about 60 to about 70, or about 65 to about 70, wt %, based on a total weight of the waterborne coating composition. In various non-limiting embodiments, all values and ranges of values, both whole and fractional, including and between the aforementioned values, are hereby expressly contemplated for use herein. In various embodiments, the coating material is free of water.

In other embodiments, the coating material is a solvent-borne coating composition. Typically, the solvent-borne coating composition can be free of water and may include a solvent, e.g. a water-soluble and/or a water-insoluble solvent. For example, the coating material may include, or be free of, one or more water-soluble solvents, such as those described above. Alternatively, the solvent-borne coating composition may include, or be free of, one or more water-insoluble solvents, including but not limited to aromatic hydrocarbons such as toluene, xylene, benzene, ethylbenzene, styrene, cumene, mesitylene, naphthalene, etc.; aliphatic hydrocarbons such as heptane, octane, nonane, decane, mineral spirits, e.g., Stoddard solvent, naphtha, kerosene, cyclohexane, etc.; esters such as butyl acetate, amyl acetate, ethyl acetate, propyl acetate, isopropyl acetate, isobutyl acetate, etc.; ketones such as methyl isobutyl ketone, diisobutyl ketone, acetophenone, cyclohexanone, isophorone, etc.; ethers such as propylene glycol monoethyl ether acetat, butyl cellosolve acetate, ethylene glycol diacetate, and diethylene glycol monoethyl ether acetate, etc.; turpentine; dibasic esters; tetrahydronaphthalene; decahydronaphthalene; etc., any and all isomers thereof, or combinations thereof.

The solvent-borne coating composition may include or be free of water. The terminology “free of water” may be used to describe an amount of less than about 5 wt % water, alternatively less than about 4, 3, 2, 1, wt % water, e.g. from about 0 and up to about 5, about 0.1 to about 4, about 0.2 to about 3, about 0.3 to about 2, about 0.4 to about 1, about 0.5 to about 1, wt %, based on a total weight of the solvent-borne coating composition. In various non-limiting embodiments, all values and ranges of values, both whole and fractional, including and between the aforementioned values, are hereby expressly contemplated for use herein.

In various embodiments, the water-soluble and/or the water-insoluble solvent is present in the solvent-borne coating composition in an amount of from about 1 to about 99, alternatively from about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55, wt % based on a total weight of the solvent-borne coating composition. In other embodiments, the water-soluble and/or the water-insoluble solvent is present in an amount of from about 40 to about 90, about 45 to about 85, about 50 to about 80, about 55 to about 75, about 60 to about 70, or about 65 to about 70, wt %, based on a total weight of the solvent-borne coating composition. Alternatively, the waterborne coating composition may be free of any one or more of the aforementioned solvents, so long as at least one solvent is present in the solvent-borne coating composition.

The coating material may include, or be free of, a resin dispersion. The resin dispersion is not particularly limited and may be any known in the art. The resin dispersion may be or include, a latex, a polyurethane, or combinations thereof.

In various embodiments, the resin dispersion is present in the coating material in an amount of from about 1 to about 50, about 1 to about 45, about 1 to about 35, about 1 to about 30, about 1 to about 25, about 1 to about 20, about 1 to about 15, about 1 to about 10, about 1 to about 5, about 5 to about 50, about 10 to about 45, about 15 to about 40, about 20 to about 35, about 25 to about 30, about 15 to about 20, about 15 to about 25, about 15 to about 30, about 10 to about 20, about 10 to about 25, about 10 to about 30, about 10 to about 35, about 18 to about 22, about 18 to about 20, about 16 to about 20, about 16 to about 22, about 16 to about 24, etc., wt % actives based on a total weight of the coating material. In various non-limiting embodiments, all values and ranges of values, both whole and fractional, including and between the aforementioned values, are hereby expressly contemplated for use herein.

In various embodiments, the latex may be or include, the reaction product of one or more of the following monomers to form a polymer which may be a dispersed phase and/or a continuous phase. These monomers may include, but are not limited to, (meth)acrylamide, N-substituted (meth)acrylamide, octyl(meth)acrylate, nonylphenol ethoxylate(meth)acrylate, isononyl(meth)acrylate, 1,6-hexanediol(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, octodecyl(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like.

In other embodiments, the latex may be, or include, one or more of (meth)acrylated urethanes (i.e., urethane(meth)acrylates), (meth)acrylated epoxies (i.e., epoxy (meth)acrylates), (meth)acrylated polyesters (i.e., polyester(meth)acrylates), (meth)acrylated(meth)acrylics, (meth)acrylated silicones, (meth)acrylated amines, (meth)acrylated amides; (meth)acrylated polysulfones; (meth)acrylated polyesters, (meth)acrylated polyethers (i.e., polyether (meth)acrylates), vinyl(meth)acrylates, and (meth)acrylated oils. In one embodiment, the resin dispersion may be, include, consist essentially of, or consist of, a polyester-modified acrylic dispersion containing epoxy groups. One non-limiting example has a trade name of Daotan® VTW 1686/40WA which is commercially available from Allnex. In another embodiment, the resin dispersion may be, include, consist essentially of, or consist of, a styrene-acrylic latex dispersion.

The resin dispersion may be or include the polyurethane. In various embodiments, the polyurethane is the reaction product of a polyol and an isocyanate.

In various embodiments, the polyol is chosen from polyester polyols, polyether polyols, and polycarbonate polyols. It is also contemplated that polythioether polyols, polycaprolactones, and acrylic polyols may also be utilized. In one embodiment, the polyol is further defined as a polyester polyol. In another embodiment, the polyol is a polyester polyol. In another embodiment, the polyol, is an aromatic polyester or polyether polyol.

The polyol may be derived from a reaction of an initiator and an alkylene oxide. The initiator may include any initiator known in the art. In various embodiment, the initiator is chosen from ethylene glycol, propylene glycol, dipropylene glycol, trimethylene glycol, butane diols, pentane diols, hexane diols, heptane diols, glycerol, 1,1,1-trimethylolpropane, 1,1,1-trimethylolethane, hexane triols, alkyl glucosides, pentaerythritol, sorbitol, diamine naphthalenes, anilines, condensation products of aniline and formaldehyde, alkyl amines, triisopropanolamine, alkylene diamines, diamine alkanes, sucrose, toluene diamine, and combinations thereof.

The polyol may include an organic functional group chosen from a carboxyl group, an amine group, a carbamate group, an amide group, and an epoxy group. The polyol may also include an alkylene oxide cap. If the polyol includes the alkylene oxide cap, the alkylene oxide cap typically includes, but is not limited to, ethylene oxide, propylene oxide, butylene oxide, amylene oxide, and combinations thereof. More typically, the alkylene oxide cap includes ethylene oxide. If the polyol includes the alkylene oxide cap, the alkylene oxide cap may be less than or equal to 25, and more typically of from 10 to 20, percent by weight based on the total weight of the polyol. In various non-limiting embodiments, all values and ranges of values, both whole and fractional, including and between the aforementioned values, are hereby expressly contemplated for use herein.

The polyol may also include an addition polymer dispersed therein. More specifically, the polyol may include a dispersion or a solution of addition or condensation polymers, i.e., a graft polyol. The dispersion may include styrene, acrylonitrile, and combinations thereof. Also, the polyol may also include an emulsion that includes water or any other polar compound known in the art.

Alternatively, the polyurethane may be described as the reaction product of a compound having one or more hydroxyl groups (e.g. a monol, diol, triol, tetrol, or polyol) and an isocyanate. Non-limiting suitable compounds include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. If desired, monohydric alcohols, such as, for example, butanol, octanol, lauryl alcohol, ethoxylated or propoxylated phenols may also be included along with polyhydric alcohols to control molecular weight.

The resin dispersion may also include an amine, which may be any type known in the art, that may or may not react with an isocyanate to form a polyurea. The amine may include, but is not limited to, primary and secondary amines aliphatic and/or cyclic aliphatic amines. The amine may include any additional functional group known in the art including, but not limited to, hydroxyl groups, thiol groups, alkyl groups, cyclic groups, aromatic groups, and combinations thereof. It is to be understood that the amine may also include an amide which also may be any type known in the art. The amide may include, but is not limited to, polyester amides obtained from polymers of unsaturated or saturated carboxylic acids or anhydrides, and multifunctional unsaturated or saturated amino-alcohols, and combinations thereof.

Referring back to the isocyanate, the isocyanate is not particularly limited and may be any described in this disclosure. In various embodiments, isocyanate may be, include, consist essentially of, or consist of 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof.

In other embodiments, the polyurethane may be, include, consist essentially of, or consists of, a polyester-polyurethane polymer. The polyester of the polyester-polyurethane polymer may be linear or branched. Useful polyesters can include esterification products of aliphatic or aromatic dicarboxylic acids, polyols, diols, aromatic or aliphatic cyclic anhydrides and cyclic alcohols. Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

Non-limiting examples of suitable polyesters include a branched copolyester polymer. The branched copolyester polymer and process for production described in U.S. Pat. No. 6,861,495, which is hereby incorporated by reference, can be suitable. Monomers with multifunctional groups such as AxBy (wherein each of x and y is independently 1 to 3) types including those having one carboxyl group and two hydroxyl groups, two carboxyl groups and one hydroxyl group, one carboxyl group and three hydroxyl groups, or three carboxyl groups and one hydroxyl group can be used to create branched structures. Non-limiting examples of such monomers include 2,3 dihydroxy propionic acid, 2,3 dihydroxy 2-methyl propionic acid, 2,2 dihydroxy propionic acid, 2,2-bis(hydroxymethyl) propionic acid, and the like.

The branched copolyester polymer can be conventionally polymerized from a monomer mixture containing a chain extender chosen from a hydroxy carboxylic acid, a lactone of a hydroxy carboxylic acid, and a combination thereof, and one or more branching monomers. Some of the suitable hydroxy carboxylic acids include glycolic acid, lactic acid, 3-hydroxypropionic acid, 3-hydroxybutyric acid, 3-hydroxyvaleric acid, and hydroxypyvalic acid. Some of the suitable lactones include caprolactone, valerolactone; and lactones of the corresponding hydroxy carboxylic acids, such as, e.g., 3-hydroxypropionic acid, 3-hydroxybutyric acid, 3-hydroxyvaleric acid, and hydroxypyvalic acid. In certain embodiments, caprolactone can is utilized. In embodiments, the branched copolyester polymer can be produced by polymerizing, in one step, the monomer mixture that includes the chain extender and hyper branching monomers, or by first polymerizing the hyper branching monomers followed by polymerizing the chain extenders. It is to be appreciated that the branched copolyester polymer can be formed from acrylic core with extending monomers described above.

The polyester-polyurethane polymer can be produced from the polyester and polyisocyanates. The polyester can be polymeric or oligomeric organic species with at least two hydroxyl-functionalities or two-mercapto functionalities and their mixtures thereof. Polyesters and polycarbonates with terminal hydroxy groups can be effectively used as the diols.

In another embodiment, the polyurethane is chosen from one formed from a branched polyester polyol and hexamethylene diisocyanate; formed from a linear polyester diol resin and isophorone diisocyanate wherein the linear polyester diol is the reaction product of 1,6-hexanediol, adipic acid, and isophthalic acid; formed from a linear polycarbonate-polyester polyol and isophorone diisocyanate; a polyester-polyurethane polymer; and combinations thereof.

In another embodiment, the resin dispersion may be, include, consist essentially of, or consist of, a polyurethane dispersion resin formed from a linear polycarbonate-polyester polyol and isophorone diisocyanate. In still another embodiment, the resin dispersion may be or include a polyester-polyurethane polymer having the tradename Bayhydrol® U 241 which is commercially available from Covestro AG of Leverkusen, Germany. In various embodiments, the resin dispersion can include core-shell particles that includes a polymeric core, urethane linkages, and carboxylic acid and hydroxyl functional groups. In other embodiments, the core-shell particles include a polymeric core at least partially encapsulated by a polymeric shell including the urethane linkages and carboxylic acid and hydroxyl functional groups, wherein the polymeric shell is covalently bonded to at least a portion of the polymeric core. In still other embodiments, at least a portion of the polymeric core of the core-shell particles includes an addition polymer formed from (meth)acrylic monomers, vinyl monomers, or combinations thereof. In additional embodiments, the core-shell particles includes urea linkages and urethane linkages and with keto functionality on the acrylic core and carboxylic acid functionality on the polyurethane shell.

The coating material may include, or be free of, a crosslinker. The crosslinker is not particularly limited and may be any known in the art. The crosslinker can include a functional group that can crosslink with the resin. Non-limiting examples of functional groups can include groups such as hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide, melamine, etc. and combinations thereof.

In various embodiments, the crosslinker is a melamine crosslinker. Suitable melamine crosslinkers may be melamine resins that are partially or fully etherified with one or more alcohols, typically methanol or butanol. Examples of melamine crosslinkers may be or include monomeric melamine, polymeric melamine resins, and combinations thereof.

Other crosslinkers may also be utilized in the coating material. For example, an isocyanate crosslinker may be utilized. Alternatively, both an isocyanate crosslinker and a melamine crosslinker can be used Examples of isocyanate crosslinkers are not particularly limited and may be any known in the art. In various embodiments, this isocyanate crosslinker is or includes an aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate.

In various embodiments, isocyanates such as oligomers derived from hexamethylene diisocyanate (HDI), diphenylmethane diisocyanate (MDI), isophorone diisocyanate (IPDI), or toluidine diisocyanate (TDI), e.g. isocyanurates, biuret, allophanates, and adducts of the isocyanates described above with polyhydric alcohols and mixtures thereof can be used as a crosslinker. These can react with polyols such as, for example, OH group-containing polyesters, polyethers, acrylates and polyurethane, and mixtures thereof, which polyols may be solvent-based, solvent-free, or water-dilutable. Additionally, the isocyanate crosslinker may be a monofunctional isocyanate, a polyfunctional isocyanate, or combinations thereof.

Polyisocyanate-functional adducts can also be used in or as the crosslinker. Non-limiting examples of such adducts include an adduct of two molecules of a diisocyanate, such as hexamethylene diisocyanate or isophorone diisocyanate, and a diol such as ethylene glycol; an adduct of three molecules of hexamethylene diisocyanate and one molecule of water; an adduct of one molecule of trimethylol propane and three molecules of toluene diisocyanate; an adduct of one molecule of trimethylol propane and three molecules of isophorone diisocyanate or compounds, such as 1,3,5-triisocyanato benzene and 2,4,6-triisocyanatotoluene; an adduct of one molecule of pentaerythritol and four molecules of toluene diisocyanate, etc.

In various embodiments, the crosslinker is present in the coating material in an amount of from about 1 to about 30, about 5 to about 25, about 10 to about 20, or about 10 to about 15 wt %, based on the total weight actives in the composition. In other embodiments, this amount is from about 1 to about 10, about 2 to about 9, about 3 to about 8, about 4 to about 7, or about 5 to about 6 wt %, based on a total weight of the coating material. In various embodiments, all values and ranges of values, both whole and fractional, including and between the aforementioned values, are hereby expressly contemplated for use herein.

The coating material may include, or be free of, an additive. The additive may be included for various applications and purposes. For example, the additive may be or include a binder, a dye, a rheology modifier, a catalyst, dispersants, antioxidants, UV stabilizers and absorbers, surfactants, wetting agents, leveling agents, antifoaming agents, anti-cratering agents, etc. or combinations thereof.

The additive may be present in the coating material in any amount as determined by the skilled person, typically from about 0 and up to about 5 wt % actives, based on a total weight of the coating material. In various embodiments, the additive is present in an amount of from about 0 and up to about 5, about 0.5 to about 4.5, about 1 to about 4, about 1.5 to about 3.5, about 2 to about 3, or about 2 to about 2.5, wt %, based on a total weight of the coating material. In other embodiments, the additive is present in an amount of from about 0.01 to about 1, about 0.05 to about 0.95, about 0.1 to about 0.9, about 0.2 to about 0.8, about 0.3 to about 0.7, about 0.4 to about 0.6, or about 0.4 to about 0.5, wt % actives, based on a total weight of the coating material. In various embodiments, all values and ranges of values, both whole and fractional, including and between the aforementioned values, are hereby expressly contemplated for use herein.

In various non-limiting embodiments, the additive may be or include an additive as described in U.S. Pat. No. 11,965,107B2, which is hereby incorporated by reference.

The coating material may exhibit various physical properties, which may be customized by the skilled person. For example, the coating material may exhibit any viscosity, depending on printing applications and/or components and amounts included in the coating materials.

The viscosity of the coating material may be measured using various methods known in the art. In various embodiments, the viscosity can be measured using a standardized technique, e.g. ASTM D562, ASTM D1200, ASTM D2196, each as published in 2025. Alternatively, the viscosity of the coating material may be determined according to using any apparatus, any instrument, etc. known in the art. In various embodiments, the viscosity is measured using an Efflux cup, a rotational viscometer, a capillary viscometer, a stormer viscometer, etc. In various embodiments, a standardized method such as ASTM 7867-13 as published in 2025 with cone-and-plate or parallel plates at various sheer rates is utilized to measure the viscosity of the coating composition. In other embodiments, the viscosity is measured using a Brookfield viscometer, using any spindle known in the art. The viscosity may be measured at various conditions, typically at a temperature of from about 10 to about 30 °C, e.g. about 15 to about 25, about 10 to about 20, etc. The viscosity may be measured at any shear rate, typically from about 0.01 to about 1000, s⁻¹. In various embodiments, the viscosity is measured at a shear rate of from about 0.01 to about 1000, alternatively from about 100 to about 1000, about 200 to about 900, about 300 to about 800, about 400 to about 700, or about 500 to about 600, s⁻¹. In other embodiments, the viscosity is measured at a shear rate of from about 0.01 to about 100, alternatively from about 0.05 to about 90, about 0.1 to about 80, about 0.2 to about 70, about 0.3 to about 60, about 0.4 to about 50, about 0.5 to about 50, about 1 to about 40, about 10 to about 30, or about 10 to about 20, s⁻¹. In various embodiments, all values and ranges of values, both whole and fractional, including and between the aforementioned values, are hereby expressly contemplated for use herein.

### Applying the Coating Material:

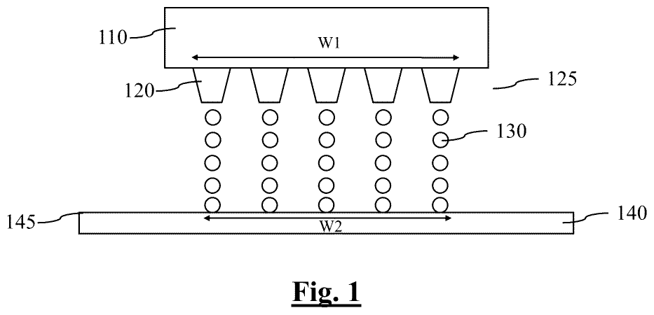

As shown in FIG. 1, the method also includes the step of applying at least two overlapping swaths (210) of the coating material (130). FIG. 1 also shows one portion of one embodiment of the step of applying the coating material (130) onto a surface (145) of a substrate (140). Generally, the application of the coating material (130) is performed using a drop-on-demand (DOD) technique, and the coating material (130) is ejected as droplets from a DOD applicator (110). For simplicity, the DOD applicator (110) is shown as a rectangle in FIG. 1. The DOD applicator (110) may be any known in the art.

The substrate (140) is not particularly limited and may be any known in the art. For example, the substrate (140) may be, or include a material chosen from a metal, e.g., iron, aluminum, copper, chrome, etc., a polymer, e.g. polyurethane, polyester, polyvinyl chloride, etc., glass, wood, etc. and combinations thereof. The surface (145) of the substrate (140) may be uncoated such that when applied, the coating material (130) is disposed on and in direct contact with the surface (145) of the substrate (140). Alternatively, the surface (145) of the substrate (140) may be coated, e.g. coated with one or more layers of primer, base coat, surfacer, etc., such that the coating material (130) is disposed on and spaced away from the surface (145) of the substrate (140). Additionally, the surface (145) of the substrate (140) may be treated using any technique known in the art, e.g. wiped, sanded, polished, etc.

The step of applying is not particularly limited. The step of applying may be further described as jetting, e.g. jetting through a DOD applicator (110). The DOD applicator (110) may be as described in any one or more of U.S. Pat. Nos. 7,824,015 B2, 8,091,987 B2, WO 2018/206309 A1, and WO 2019/108938 A1; each of which is expressly incorporated herein in its entirety in various non-limiting embodiments. Similarly, a method of using the DOD applicator (110) and/or any one or methods or steps described herein may alternatively be as described in one or more of the aforementioned references.

In various embodiments, the step of applying may be further described as printing, e.g. digital printing, DOD printing, etc. The DOD printing may be performed using any equipment known in the art, and may employ various mechanisms to print, e.g. thermal DOD, piezoelectric DOD, etc.

In various embodiments, the step of applying uses the DOD applicator (110), e.g. to generate and eject droplets of the coating material (130) only when needed, e.g. rather than continuously, which can improve precision of droplet placement and minimize waste. The DOD applicator (110) can create a pressure pulse which forces the droplets of the coating material (130) through a plurality of nozzles (120), e.g. of the DOD applicator (110). In various embodiments, the DOD applicator (110) includes the plurality of nozzles (120), as shown in FIG. 1. In various embodiments, the plurality of nozzles (120) may be arranged in an array of nozzles (125).

The plurality of nozzles (120) is not particularly limited. For example, each of the plurality of nozzles (120) may define an orifice having a diameter. The diameter of the orifice can vary, e.g. depending on DOD application, products to be printed on, desired spatial resolution, etc. In various embodiments, the diameter of the orifice may be from about 10 to about 500 microns. In various embodiments, the diameter of the orifice is from about 50 to about 450 microns, about 100 to about 400, about 150 to about 350, or about 200 to about 300 microns, depending on the type of the applicator and the applications. In various non-limiting embodiments, all values and ranges of values, both whole and fractional, including and between the aforementioned values, are hereby expressly contemplated for use herein.

Depending on the diameter of the orifice and amount of coating materials (130) to be applied, the droplets of the coating material (130) may vary in particle size distribution. For example, the droplets may have a particle size distribution Dv10, Dv50, Dv90, Dv99, Dn10, Dn50, Dn90 and/or Dn99 each independently as described below, e.g. each independently of from about 10 to about 100, about 20 to about 90, about 30 to about 80, about 40 to about 70, about 50 to about 60, microns. The particle size of the droplets may be determined using any apparatus known in the art. In various embodiments, the particle size is determined using a high-speed stroboscopic imaging device to capture images of the droplets mid-flight for analysis. The high-speed stroboscopic imaging device may be configured as determined appropriate by one skilled in the art. In various embodiments, the device is a JetXpert® dropwatcher system, a product of ImageXpert. LLC., which uses a high-speed camera and strobe light synchronized with the printhead to capture images of individual droplets in flight, allowing detailed analysis of drop size. In various non-limiting embodiments, all values and ranges of values, both whole and fractional, both between and including each of the above, are hereby expressly contemplated for use herein.

The above droplets may have various shapes, for example, spherical, spheroidal, cylindrical, geometric, or irregular shape. In various embodiments, the aforementioned Dv10, Dv50, Dv90, Dv99, Dn10, Dn50, Dn90 and/or Dn99 particle size can be used to describe droplets of any shape. As used herein, “nominal dimension” refers to a reference dimension of the droplet. If the droplet is a sphere, then the nominal dimension is defined as the diameter of the spherical droplet. If the droplet is not a sphere, then the nominal dimension is defined as the largest dimension of the droplet.

As used herein, the “average nominal particle dimension” or “Dn50 nominal particle dimension” refers to a measurement below which the nominal dimension of 50% of the droplets by volume in the population falls. As used herein, the “Dn90 nominal particle dimension” refers to a measurement below which the nominal dimension of 90% of the droplets by volume in the population falls. As described herein, Dn50 and Dn90 nominal particle dimensions are measured using the aforementioned method and may be described using the aforementioned values and ranges of values as described above.

### Overlapping Swaths:

Referring back, the terminology “swath” may be used to describe a strip/a stripe/a swathe of the coating material (130) applied in a single pass. Each swath (210) independently can be straight, curved, zigzag, etc., or combinations thereof. Typically, each swath (210) independently has a width (W2) that is approximately the same as a width (W1) of the array of nozzles (125). Additionally, it may be understood by the skilled person that one or more of the plurality of nozzles (120) may be blocked, deactivated, etc. such that the width (W2) of the swath (210) is smaller than the width (W1) of the array of nozzles (125).

The step of applying is performed to achieve a target dry film thickness, which may be further described as a thickness of a layer of the coating material (130), e.g. after drying/curing. The target dry film thickness may be customized for various applications and purposes, e.g. to provide protection from repetitive use, weather, sunlight, etc., to provide a certain level of coverage and/or color intensity, etc. The target dry film thickness may be abbreviated as DFT and may be described as a thickness achieved after drying and/or baking. The target dry film thickness may vary and may be from about 1 to about 100 microns, e.g. about 1 to about 20 microns, about 2 to about 19, about 3 to about 18, about 4 to about 17, about 5 to about 16, about 6 to about 15, about 7 to about 14, about 8 to about 13, about 9 to about 12, or about 10 to about 11, microns. Alternatively, the target dry film thickness may be from about 20 to about 100, e.g. about 25 to about 95, about 30 to about 90, about 35 to about 85, about 40 to about 80, about 45 to about 75, about 50 to about 70, or about 55 to about 65, microns. In various non-limiting embodiments, all values and ranges of values, both whole and fractional, both between and including each of the above, are hereby expressly contemplated for use herein.

The target dry film thickness as described above may be achieved with one coat of the coating material (130), i.e. single-coat application. Alternatively, the target dry film thickness may be achieved with two, three, four, or more coats of the coating material (130), i.e. multiple-coat application. In a multiple-coat application, each individual coat may have approximately the same thickness as, or a different thickness from, another coat.

The target dry film thickness may be evaluated using various methods which may be selected by the skilled person. For example, the target dry film thickness may be evaluated using a high-ink sticker, which may be applied onto a portion of the surface (145) of the substrate (140). Generally, a suitable value of the target dry film thickness can provide coverage such that the high-ink sticker is not visible when observed by the naked eye. In the alternative, the target dry film thickness may be quantitatively measured using a profilometer, a caliber, an imaging technique, e.g. electron microscopy, etc.

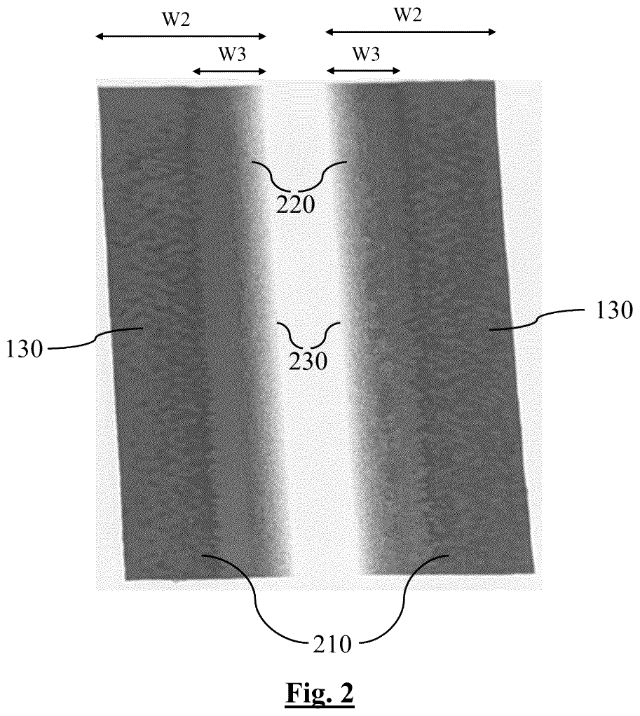

The swath (210) may have a heterogenous film thickness across the width (W2) of the swath (210), i.e. a density gradient, as shown in FIGS. 2, 4 and 5. The density gradient and its purposes will be made clear in the subsequent sections. The density gradient may be achieved by using any printing technique/program/algorithm, e.g. to control amounts of coating material (130) to be ejected, via controlling volume, and particle size distribution of the droplets of the coating material (130), and/or frequency of droplet ejection from one or more of the plurality of nozzles (120). For example, the particle size distribution of the droplets may gradually decrease/taper, e.g. using grey scaling. In the alternative, other algorithms may be used to adjust the droplets being ejected, e.g., pattern-based volume alterations such as dithering, half-tone-screening, gradients, random dot printing, etc. In various embodiments, the step of applying is further defined as random dot printing. i.e. ejection of droplets of the coating material (130) is randomized. In other embodiments, a combination of the aforementioned methods may be used. Different methods may be used at different stages of printing processes, for example, an initial study or surveying stage may use one technique and a refinement stage may use a different technique.

The ejection of droplets of the coating material (130) may be performed using various strategies, e.g., by ejecting fewer/more droplets over a given area to alter the droplet density, for example, by using the non-firing or “white” droplets to reduce the on-substrate droplet density, by altering the volume/particle size distribution of the droplets being ejected, etc. Simple methods such as tapering the number of droplets ejected may be utilized, or more complex algorithms as described above may be used.

### Creating the Density Gradient

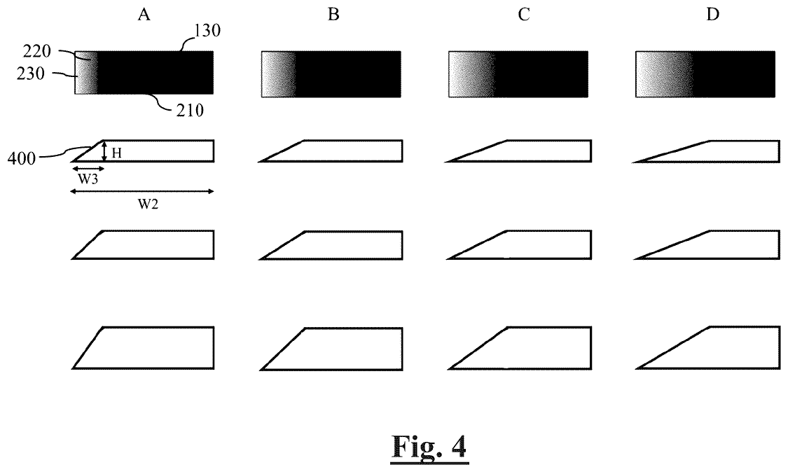

The method further includes the step of creating the density gradient along the edge (230) of at least one swath (210) to generate a transition zone (220), as shown in FIGS. 2 and 4. The edge (230) may be approximately straight, curved, or zigzag, etc. In various embodiments, coating material migration is minimal or not present such that the edge (230) is approximately straight. In other embodiments, the coating material migrates/diffuses such that the edge (230) is approximately curved, e.g. concave, convex, or combinations thereof.

The step of creating the density gradient is not particularly limited. In various embodiments, the step of creating the density gradient is further defined as creating a gradient of film thickness. Accordingly, the transition zone (220) may be further described as a region of the swath (210), where the gradient of film thickness occurs. The gradient of film thickness may be further described as gradient of wet film thickness or gradient of dry film thickness, e.g. depending on whether and when curing/drying is performed.

In various other embodiments, the step of creating the density gradient is further defined as creating a gradient of droplets of the coating material (130), typically measured per inch of the surface (145) of the substrate (140). Accordingly, the transition zone (220) may be further described as a region in the swath (210) defined by the edge (230) and a location where the gradient of drops occurs.

The transition zone (220) has a width (W3), that can be adjusted based on a target dry film thickness, e.g. to achieve a certain value of a slope (400) of the transition zone (220), the purpose of which will be made clear in the following section.

The width (W3) of the transition zone (220) may be smaller than the width (W2) of the swath (210), i.e. greater than about 0% and less than about 100% the width (W2) of the swath (210). Utilizing large widths (W3) of the transition zone (220), e.g. greater than about 50%, may achieve certain desirable value of the slope (400) but may result in increasing numbers of swaths and/or coats, e.g. to meet a desired level of coverage, color intensity, weather protection, etc. Typically, the width (W3) of the transition zone (220) is customized to be less than about 100%, alternatively equal to or less than 90%, equal to or less than 80%, equal to or less than 70%, equal to or less than 60%, equal to or less than 50%, equal to or less than 40%, equal to or less than 30%, or equal to or less than 20%, the width (W2) of the swath. Alternatively, the width (W3) of the transition zone (220) may be from about greater than about 0% and up to and including about 50%, or about 10 to about 50, about 15 to about 45, about 20 to about 40, about 25 to about 35, or about 25 to about 30, % the width (W2) of the swath. In various non-limiting embodiments, all values and ranges of values, both whole and fractional, both between and including each of the above, are hereby expressly contemplated for use herein.

The step of creating the density gradient may be performed before, after or concurrently with the step of applying. The step of creating the density gradient may be performed once or more than once, depending on stages of a printing process, e.g. initial study or surveying stage versus refining stage.

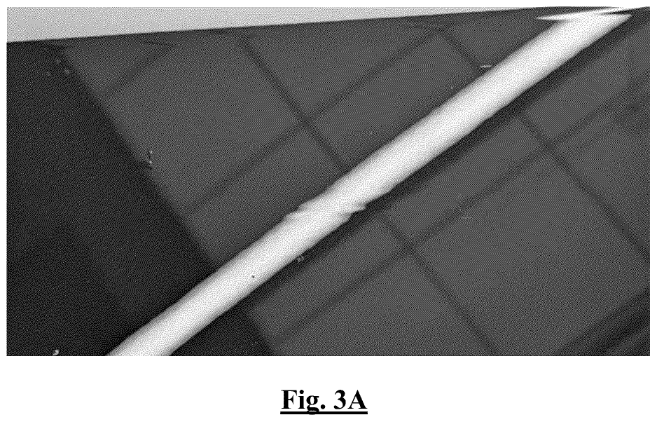

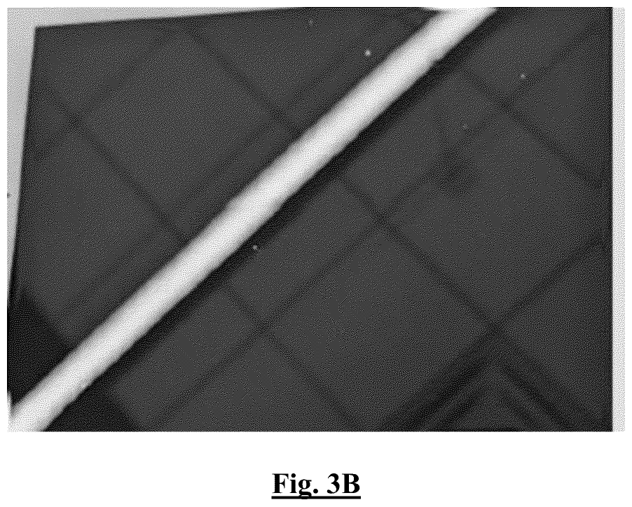

In various embodiments, the step of creating the density gradient is performed using an image manipulation technique. The terminology “image manipulation” may be used to describe a process of altering an image, a pattern, a text, etc., for various purposes, e.g. to achieve a certain visual and/or physical property, to adjust and/or offset a certain physical phenomenon, to minimize various printing defects, etc., and combinations thereof. For example, image manipulation may be used to adjust for diffusion/migration of the coating material (130) on the surface (145) of the substrate (140), e.g. post application but before curing, which can otherwise lead to defects such as reduced image resolution, heterogenous coating thickness, etc., thereby achieving a uniform surface appearance and minimizing visible overlap defect, e.g. as shown in FIG. 3B.

Various image manipulation strategies may be used, any of which may be performed using manual calculations, computational modeling, mathematical adjustment based on empirical data, etc., using any tool, equation, and/or computational program as deemed appropriated by the skilled person. In various embodiments, image manipulation is utilized and the step of creating the density gradient is further defined as the steps of obtaining image data and the target dry film thickness, determining a variation from the target dry film thickness at one or more points of the transition zone (220), and forming compensated image data.

The step of obtaining image data and the target dry film thickness is not particularly limited. For example, the image data may include information regarding the image to be printed, e.g. pixel data, metadata, image dimension and resolution, etc., geometric information for the substrate to be printed on, which may be provided with the image data or separately, e.g. as a CAD data, or from a surface scan of the substrate to be printed on. The image itself is also not limited, and may be any image determined by the skilled person, e.g. having any shape, size, color, layer, spatial resolution, etc.

Furthermore, the step of determining a variation may be any known in the art. For example, the step of determining may be physically performed/measured, e.g. using a profilometer, a caliber, surface probes, interferometry, etc. Alternatively, the step of determining a variation may be performed computationally, e.g. estimated using any known techniques, using a computational model/mathematical calculation, etc. The variation may be determined for one or more points of the transition zone (220). A point may be described as a single pixel or a cluster/grouping of pixels, which can be customized for different applications, capability of the printer, and/or desired appearance. Additionally, the variation may be determined at a representative collection of points, e.g. in the transition zone (220), rather than at every point where a droplet is to be deposited. The variation may be described as a deviation, which may be expressed as a difference, a ratio, a percentage, etc. of thickness, between the target dry film thickness and the point(s) of the transition zone (220).

The step of forming compensated image data is also not limited. In various embodiments, the step of forming is typically performed after the step of determining. The variation obtained from the step of determining may be utilized in forming compensated image data, thereby creating the density gradient. In some embodiments, the compensated image data includes data on film thickness to compensate for the variation in film thickness. In other embodiments, the compensated image data includes data on droplet variation, e.g. volume, size, frequency, etc. to compensate for the variation in film thickness. In yet other embodiments, the compensated image data includes data on both film thickness and droplet variation to compensate for the variation in film thickness. It may be generally understood that at a point where there is no thickness variation, the image data for that point in the transition zone (220) may remain unchanged during and/or after the step of forming compensated image data.

The step of forming compensating image data may include any calculation, as determined by the skilled person. In various embodiments, the step of forming includes interpolation method, e.g. to determine droplet volume compensations for points where a droplet is to be ejected, based on the variation at the representative collection of points in the transition zone (220).

The steps included in the image manipulation may be performed in any order, as deemed suitable by the skilled person. Furthermore, any one or more steps may be performed one or more times. For example, for an initial study or surveying stage, the step of determining may be performed, followed by the step of forming compensated image data, followed by a repetition of the steps of determining a variation and forming compensated image data, e.g. to account for any residual variation not addressed in the first round of image manipulation.

In various embodiments, one or more test substrates (not shown in FIG. 1) may be formed by ejecting a test pattern of droplets from the plurality of nozzles (120) onto the surface(s) of one or more test substrates. The coating material (130) may be allowed to dry. The test pattern of droplets may, for example, produce an image of a square or a rectangle formed by a number of droplets of known droplet volumes.

It may be understood that the test substrates may have the same or similar shape and geometric orientation as that of the desired substrate, or they may be representative of a range of shapes and orientations. For example, for printing onto inclined surfaces a range of test substrates inclined at a range of angles to the horizontal from 0° to 90° may be used, e.g. alternatively about 5 to about 85, 10 to about 80, about 15 to about 75, about 20 to about 70, about 25 to about 65, about 30 to about 60, about 35 to about 55, about 40 to about 50, or about 40 to about 45, °. In various non-limiting embodiments, all values and ranges of values, both whole and fractional, both between and including each of the above, are hereby expressly contemplated for use herein.

Once the test substrate(s) have been produced and the droplets have dried, the variation from the target dry film thickness may be determined at a representative collection of points on the one or more test substrates. The variation may be determined by measurement, for example using surface probes, profilometer, interferometry, laser scanners, etc. or any other suitable method to measure the thickness variation at one or more points on the test substrate and/or the desired substrate. The thickness variation on a desired substrate may be determined by interpolation from the test substrates (for example if the desired substrate is angled at 450 to the horizontal, and there are test substrates oriented at 400 and 50° to the horizontal, then an interpolation routine may be used to determine the thickness variation on the desired substrate, i.e. angled at 45°.

Alternatively, rather than printing test substrates for every desired substrate and application, the thickness variation may be determined using a lookup table; or by using mathematical models and calculations. The lookup table and/or the calculations may be based on various parameters such as fluid type, ambient conditions, properties of the complex substrate, etc. Where the thickness variation is determined using a lookup table, this may have been populated using data from a plurality of test substrates, for example, or by using mathematical models and predictions. The process of producing data for a lookup table from a plurality of test substrates may be done for the desired fluid, or for certain test fluids with certain properties. The test fluids, for example, may be for certain viscosities and/or particle loadings and/or particle sizes, and/or carrier fluid types and/or carrier fluid % volumes, and/or temperatures, etc.

### Controlling a Slope

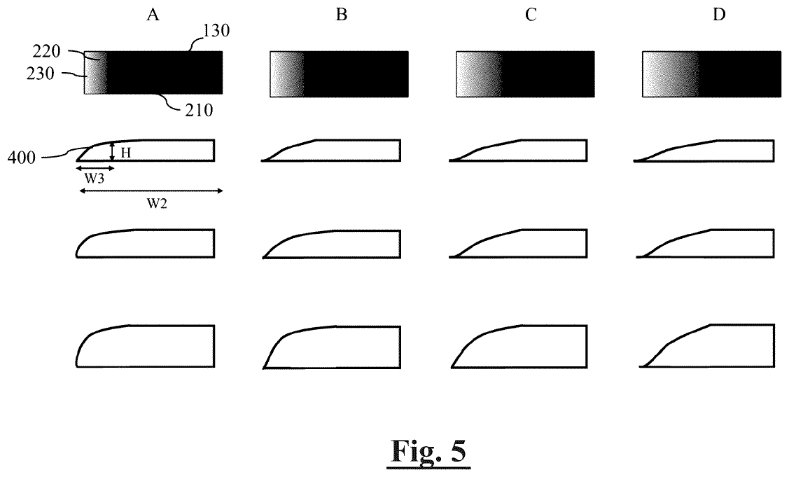

The method further includes the step of controlling a slope (400) of the transition zone (220). In various embodiments, the value of slope (400) is calculated by diving a height (H) of the transition zone (220) by the width (W3) of the transition zone (220), as shown in FIGS. 4 and 5. In various other embodiments, the value of the slope (400) may be calculated using empirical data obtained from a profilometer. In various embodiments, inherent surface roughness and other phenomena may cause a deviation of the slope (400) from linearity, e.g. as shown in FIG. 5, which may be accounted for using any technique known in the art, e.g. surface smoothening, fitting the empirical data to a model and/or mathematical equation, etc.

In various embodiments, the method is further described as a one-coat method and the height (H) of the transition zone (220) is approximately the same as the target dry film thickness, within a deviation of from about 0 and up to about 50%, alternatively from about 0.5 to about 25%, about 1 to about 20, about 1 to about 10, about 1 to about 5%. In various other embodiments, the method is further defined as a two-coat, three-coat, or multicoat method, and the height (H) of the transition zone (220) is different from the target dry film thickness, but is approximately the same as a desired thickness of a certain coat layer. In yet other embodiments, the height (H) of the transition zone (220) is different from the target dry film thickness and/or a desired thickness of a certain coat layer. In various non-limiting embodiments, all values and ranges of values, both whole and fractional, both between and including each of the above, are hereby expressly contemplated for use herein.

Each of the height (H) and the width (W3) of the transition zone (220) may be measured using any method known in the art, e.g. profilometer, a caliber, surface probes, interferometry, an imaging technique, e.g. electron microscopy, etc. Alternatively, each of the height (H) and the width (W3) of the transition zone (220) may be calculated, e.g. using parameters obtained from DOD systems, etc. The skilled person appreciates that while any method known in the art may be used to obtain values for the height (H) and the width (W3) of the transition zone (220), using the same method of measurement for both the height (H) and the width (W3) can reduce or eliminate various statistical and instrumental errors.

The slope (400) is controlled to a value less than about 0.45 microns per millimeter. Without being bound by theory, it is hypothesized that the small value of the slope (400) provide a gradual transition and minimal abrupt changes in film thickness, thereby softening/smoothening the transition between swaths (210) and minimizing visible overlap. In various embodiments, the value of the slope (400) is from about 0.01 to about 0.45, about 0.05 to about 0.45, about 0.1 to about 0.4, about 0.15 to about 0.4, about 0.2 to about 0.4, about 0.25 to about 0.35, or about 0.25 to about 0.35, microns per millimeter. In various non-limiting embodiments, all values and ranges of values, both whole and fractional, both between and including each of the above, are hereby expressly contemplated for use herein.

The slope (400) may be described as positive, i.e. having a positive mathematical sign, or negative, i.e. having a negative mathematical sign. Accordingly, the value of the slope (400) may be from about ±0.01 to about ±0.45, about ±0.05 to about ±0.45, about ±0.1 to about ±0.4, about ±0.15 to about ±0.4, about ±0.2 to about ±0.4, about ±0.25 to about ±0.35, or about ±0.25 to about ±0.35, microns per millimeter. In various non-limiting embodiments, all values and ranges of values, both whole and fractional, both between and including each of the above, are hereby expressly contemplated for use herein.

In various embodiments, the value of the slope (400) may have a deviation, e.g. resulting from a statistical uncertainty and/or a deviation in measurement. The deviation may be from about 0 and up to about 10%, about 0.1 to about 5%, about 0.5 to about 5%, about 0.1 to about 1%, or about 0.5 to about 1%. In various non-limiting embodiments, all values and ranges of values, both whole and fractional, both between and including each of the above, are hereby expressly contemplated for use herein.

Alternatively, the value of the slope (400) may be calculated/measured in a unit that is different from microns per millimeter such that the value and/or deviation of the slope (400) may be outside one or more ranges described above.

It is generally understood that to achieve the value of the slope (400), the width (W3) of the transition zone (220) is proportionally adjusted based on the target dry film thickness. For example, for greater target dry film thickness, a greater width (W3) of the transition zone (220) is utilized.

### Minimize Overlap Visibility

The method described herein minimizes overlap visibility, e.g. of a substrate coated with a coating material, i.e. an article. The overlap visibility may be observed/detected using any method known in the art. In various embodiments, the overlap visibility is determined by a lack of reflective distortion on the surface (145) of the substrate (140) after the step of applying. In various other embodiments, the overlap visibility may be observed by the naked eye, where lack of overlap visibility may be observed in FIG. 3B and presence of overlap visibility may be observed in FIG. 3A.

### Additional Steps:

The method may further include, or be free of, an additional step, that may be performed in any order with respect to the aforementioned steps. For example, certain coating applications and stage of development, e.g. initial study vs. refinement stage, an additional step may be performed.

In various embodiments, the method further includes, or is free of, a step of adjusting the width (W3) of the transition zone (220). In other embodiments, the method includes a step of drying/curing the coating material (130) may be employed. In yet other embodiments, the method further includes, or is free of, a step of measuring thickness of one or more points in the swath (210). In still other embodiments, the method includes, or is free of, a step of printing two swaths (210) that are not overlapping, e.g. to demonstrate an orientation and/or location of the swaths (210), e.g. as shown in FIG. 2. The skilled person understands that the swaths (210) shown in FIG. 2 are non-overlapping to show visual properties of each swath (210) and that in practice, the swaths (210) are applied such that they overlap in the manner described above.

In various other embodiments, the coating material (130) diffuses and/or migrates before the drying/curing occurs such that the slope (400) is not linear, e.g. as shown in FIG. 5, and the method further includes the step of accounting for a deviation from linearity, thereby assisting in the calculation of the value of the slope (400).

### ADDITIONAL EMBODIMENTS

In various additional embodiments, the method includes the step of applying two overlapping swaths (210) and the step of creating is further defined as creating a density gradient along the edge (230) of each of the two overlapping swaths (210) to generate two transition zones (220) such that the two transition zones (220) overlap and have the slopes (400) that are the same in numerical value and opposite in sign, as shown in FIG. 2. The swaths (210) in FIG. 2 are shown spaced apart, e.g. as opposed to overlapping, to visually demonstrate an orientation and position of the swaths (210). The numerical value of the slopes (400) may be approximately the same, within a deviation of about 50%, alternatively about 40%, about 30%, about 20%, about 10%, about 5%, about 1%, etc. In various non-limiting embodiments, all values and ranges of values, both whole and fractional, both between and including each of the above, are hereby expressly contemplated for use herein.

By using the instant method, defects from misalignment of transition zones (220) may be minimized. Misalignment defects may be observed in methods where density gradients are more precisely controlled and/or amount of coating materials (130) are specifically assigned for precise locations on the swaths (210). Accordingly, the two overlapping swaths (210) may be positioned in any orientation and/or location. In various embodiments, the two overlapping swaths (210) are positioned approximately parallel to one another, such that the transitions zones have at least 50% overlapping by area, alternatively, at least about 60, at least about 70, at least about 80, at least about 90, at least about 95, or at least about 99, % of the transition zones (220). In various non-limiting embodiments, all values and ranges of values, both whole and fractional, both between and including each of the above, are hereby expressly contemplated for use herein.

In various other embodiments, the method includes the step of applying three or more overlapping swaths (210). Accordingly, one or more of the swaths may be adjacent to and overlap with one or more swaths (210), such that it is possible to have two, three, four, etc. transition zones (220). For example, three parallel adjacent and overlapping swaths (210) may be applied; the middle swath (210) can have two transition zones (220), each overlapping the transition zone (220) on either side of the swath (210). The numerical value of the slopes (400) of the two transition zones (220) of the middle swath (210) may be approximately the same or different from one another.

In yet other embodiments, the method includes the step of applying at least two swaths (210) that are non-parallel, for example, to form a star shape. Accordingly, the edges (230) may intersect at an angle, of from greater than about 0 and up to less than about 180°. In various embodiments, the angle is from about 1 to about 179, about 10 to about 170, about 20 to about 160, about 30 to about 150, about 40 to about 140, about 50 to about 130, about 60 to about 120, about 70 to about 110, about 80 to about 100, or about 80 to about 90°. The numerical value of the slopes (400) of the two transition zones (220) of the middle swath (210) may be approximately the same or different from one another. In various non-limiting embodiments, all values and ranges of values, both whole and fractional, both between and including each of the above, are hereby expressly contemplated for use herein.

In various embodiments, the method includes the step of applying three or more swaths (210) that are non-parallel whose transition zones (220) overlap in approximately the same location on the surface (145) of the substrate (140).

In various embodiments, the target dry film thickness is achieved by applying two or more coats. The swaths (210) used to form a second coat may be approximately the same shape and placed on the approximately the same location as the swaths (210) used to form first coat. Alternatively, the swaths (210) used to form a second coat may be approximately a different shape and/or placed on a different location as the swaths (210) used to form first coat. In a nonlimiting embodiment, the target dry film thickness is achieved by applying two coats wherein the first and the second coat are both formed from the same solvent-borne coating composition.

### Examples

Various substrates were coated with either Coating Composition 1 or 2. The substrates utilized in the Examples described herein were E-coated steel panels coated using a 3-wet process (primer, white basecoat and clear coat) and cured prior to application of the Coating Composition 1 or 2. The Coating Compositions were prepared using the components as set forth in Tables 1 and 2.

TABLE 1
Components included in Coating Composition 1.

| | Weight | |
|---|---|---|
| Component | % | Description |
| Melamine Resin | 1.76 | Methylated, isobutylated, melamine |
| | | formaldehyde resin with a high degree of |
| | | alkylation (hexaether), i.e. CYMEL ® 1168 |
| Melamine Crosslinker | 6.35 | Highly monomeric, methylated/iso-butylated |
| | | melamine crosslinker with a high degree of |
| | | alkylation, i.e. CYMEL ® 1161 |
| Solvent I | 6.75 | N-Butyl Alcohol |
| Melamine Crosslinker | 0.04 | Highly methylated, n-butylated melamine |
| | | crosslinker with a high degree of alkylation, i.e. |
| | | i.e. CYMEL ® 1133 |
| Rheology Control | 2.21 | Acrylic resin, particle diameter ~300 nm |
| Agent | | dispersed in heptane (69% solids in heptane and |
| | | mineral spirits), |
| Surface Additive | 0.08 | solution of 52% polyether modified methylalkyl |
| | | polysiloxane/42.9% mineral spirit/5.1% |
| | | propylene glycol monomethyl ether acetate |
| Acrylic Resin 1 | 0.09 | High solids acrylic resin: 71% solids, 11% |
| | | styrene, 21% Butyl Methacrylate, 12% Butyl |
| | | Acrylate, 27% Hydroxypropyl Acrylate (71% |
| | | solids in Aromatic 100), |
| Sag Control Agent | 30.64 | Polyurea crystals 3% active in Acrylic resin 1, |
| Light Stabilizer | 0.22 | Hindered amine light stabilizer, derived from an |
| | | amino-ether, i.e. TINUVIN ® 123 |
| Curing Aid | 2.31 | Trimethyl Orthoacetate |
| Urethane Resin | 11.09 | Low Tg Urethane Oligomer, 80% solids, 49% |
| | | isocyanate, 7% cyclohexanol, 23% 2-ethyl |
| | | hexanol, |
| DDBSA Acid Catalyst | 1.02 | Dodecylbenzenesulfonic Acid |
| | | Diisopropanolamine CYCAT ® 600A |
| | | CATALYST |
| Ultraviolet Absorber/ | 4.19 | UVA screener/HALS solution derived from an |
| Hindered Amine Light | | amino-ether with benzotriazole, i.e. TINUVIN ® |
| Stabilizer | | 1130 and TINUVIN ® 123 |
| Pigment | 8.79 | Carbon black pigment dispersion (13.5% pigment |
| | | 28% solids in N-Butyl propionate) |
| Solvent II | 16.08 | Butyl Acetate |
| Acrylosilane Resin I | 4.67 | Hydroxy functional acrylosilanepolymer, 8000 |
| | | Mw, 70% solids, 10% butyl alcohol, 20% |
| | | aromatic 100 |
| Acrylosilane Resin II | 3.73 | Hydroxy functional, acrylosilane polymer, 6500 |
| | | Mw, 71% solids, 8% butyl alcohol, 21% aromatic |
| | | 100 (21%) |

TABLE 2
Components included in Coating Composition 2.

| | Weight | |
|---|---|---|
| Component | % | Description |
| Solvent I | 5.38 | N-Butyl Alcohol |
| Melamine Resin | 21.63 | Penta-methoxy methyl/n-butyl melamine |
| | | formaldehyde resin. Its 94% is dissolved in n- |
| | | butanol. Commercially obtained as Resimene ® |
| | | CE-4514 |
| Rheology Control | 5.22 | Acrylic resin, particle diameter ~300 nm |
| Agent | | dispersed in heptane (69% solids in Heptane and |
| | | mineral spirits), |
| Leveling Agent | 0.28 | Acrylic polymer cut 50% in aromatic 100 used |
| | | primarily as a flow and leveling agent, i.e. |
| | | Resiflow ® S |
| Curing Aid | 1.46 | Trimethyl Orthoacetate |
| Urethane Resin | 28.72 | Low Tg Urethane Oligomer, 80% solids, 49% |
| | | isocyanate, 7% cyclohexanol, 23% 2-ethyl |
| | | hexanol, |
| DDBSA Acid Catalyst | 2.29 | Dodecylbenzenesulfonic Acid |
| | | Diisopropanolamine, i.e. CYCAT ® 600A |
| | | CATALYST |
| Ultraviolet Absorber/ | 5.83 | UVA screener/HALS solution based on an |
| Hindered Amine Light | | amino-ether with benzotriazole, i.e. TINUVIN ® |
| Stabilizer | | 1130 and TINUVIN ® 123 |
| Pigment | 9.09 | Carbon black pigment dispersion (13.5% |
| | | pigment 28% solids in N-butyl propionate) |
| Acrylosilane Resin II | 6.04 | Hydroxy functional, acrylosilane polymer, 6500 |
| | | Mw, 71% solids, 8% butyl alcohol, 21% |
| | | aromatic 100 (21%) |
| Resin Intermediate | 14.06 | 60% solids solution of Downsil ™ RSN-6018 in |
| Solution | | butyl acetate, |

### Application of the Coating Composition:

The coating compositions set forth above were applied onto surfaces of the substrates, using a Xaar 2002 printhead, as set up using the protocol below.

### Calibration:

A series of calibration steps were performed to optimize jetting and ensure accurate film build. A voltage ladder was conducted for each individual row on Kodak photo paper to evaluate the jetting quality. A drop-per-inch (DPI) ladder test followed on 12″×18″ E-coated steel panels to establish a desired target dry film build at different resolutions, with measured thicknesses of 0.3 mils at 225 DPI, 0.4 mils at 360 DPI, and 0.6 mils at 540 DPI. Additionally, alignment grids were printed to determine swathe width of 70.2 mm, e.g. to establish image overlap during printing.

### Experiment Setup:

Twelve 8-bit BMP images were generated using a Python script with specific parameters. Each image was 2000 pixels wide, with an adjustable pixel length to match the DPI settings of the three different layering processes such that each printed image was 8 inches long. The grayscale resolution was set to 7 dpd and overlap widths of 20% (400 pixels), 30% (600 pixels), 40% (800 pixels), and 50% (1000 pixels) as percentage of head width and evaluated for their impact on final print quality. For the transition zone, a pixel density gradient pattern was used where the density varied uniformly across the width from 100% to 0% at the edge of the image. This pixel density distribution was randomized across the length of the image. The overlapping sections of the subsequent images were generated to be the mirror distribution of the previous image printed.

### Experiment Details:

Using a Xaar 2002 GS12 printhead with the Hydra circulation system, Coating Composition 1 was applied onto the substrates (4″×12″). Pre-established calibration values were used to guide the print process for accurate swathe alignment and film thickness consistency across the layered prints. Run details are summarized in Table 3. In table 3, print index describes the distance the printhead moves to complete two overlapping swaths, i.e. calculated as the width of the swath (W2) subtracted by the width of the transition zone (W3).

TABLE 3
Run conditions for substrates

| | | Overlap | Print |
|---|---|---|---|
| | | (% of Print | Index |
| Run | DPI | Width) | (mm) |
| 1 | 225 | 20% | 56.16 |
| 2 | 225 | 30% | 49.14 |
| 3 | 225 | 40% | 42.12 |
| 4 | 225 | 50% | 35.1 |
| 5 | 360 | 20% | 56.16 |
| 6 | 360 | 30% | 49.14 |
| 7 | 360 | 40% | 42.12 |
| 8 | 360 | 50% | 35.1 |
| 9 | 540 | 20% | 56.16 |
| 10 | 540 | 30% | 49.14 |
| 11 | 540 | 40% | 42.12 |
| 12 | 540 | 50% | 35.1 |

All runs in Table 3 were printed across the length of the panels at 50 mm/sec with two total stripes in a one-coat process to create two total overlap interfaces, i.e. transition zones. Each panel was flashed within the printing enclosure at ambient temperature for 1 minute and then cured in an oven at 140 °C for 15 minutes.

The substrates resulting from the twelve runs were evaluated for overlapping visibility defects and ranked (R) on a scale of 1 to 5, reported in Table 4. More specifically, a ranking of 5 (R=5) indicates a surface that is free of visible overlapping defects, i.e. lack of reflective distortion. A ranking of 1 (R=1) indicates a surface that shows significant visible overlapping defects. Rankings of 3 (R=3) and 4 (R=4) indicate that visible overlapping defects are minimal and/or difficult to observe. A ranking of 2 (R=2) shows unacceptable amount/level of surface defects. In short, a ranking of 3 or greater is considered desirable.

TABLE 4
Calculated slopes of transition zones
and overlapping defect rankings

| | 20% | 30% | 40% | 50% |
|---|---|---|---|---|
| Film build | gradient | gradient | gradient | gradient |
| (μm) | (14 mm) | (21 mm) | (28 mm) | (35 mm) |
| 7.6 | 0.54 (R = 1) | 0.36 (R = 4) | 0.27 (R = 5) | 0.22 (R = 4) |
| 10.3 | 0.74 (R = 1) | 0.49 (R = 1) | 0.36 (R = 4) | 0.29 (R = 5) |
| 15.2 | 1.1 (R = 1) | 0.72 (R = 1) | 0.54 (R = 2) | 0.43 (R = 3) |

Results in Table 4 demonstrate that substrates having a slope value of less than about 0.45 microns per millimeter, i.e. from about 0.22 to about 0.43 microns per millimeter, have surfaces that are free of overlapping defects or have reduced overlapping defects, e.g. compared to substrates having a slope value equal to or greater than 0.45 microns per millimeter, i.e. from about 0.49 to about 1.1 microns per millimeter. Overall, by applying the coating composition such that the slope value is equal to or greater than 0.45 microns per millimeter, printing quality can be improved by softening transitions between swaths and reducing overlap visibility.

The instant method (Table 5, B) was further compared against a conventional method (Table 5, A) that used a 50% uniform overlap, i.e. no gradient. Coating Composition 2 was applied on the substrates using a two-coat process, each coat applied using the experiment setup and details as described above. A step of flashing at ambient temperature for 1 minute was performed between each coat.

TABLE 5
Comparison of the instant method and convention
method in a two-coat process.

| Process | A | B |
|---|---|---|
| Transition Zone | 50% dither | 50% gradient |
| DFT | 33.6 | 32 |
| Overlap Ranking | R = 1 | R-3 |

Results in Table 5 show that by using the method disclosed herein (B), overlapping visibility is improved, i.e. from a ranking of 1 to a ranking of 3, while using the same coating composition to achieve approximately the same DFT. Visualization of overlapping defects can be observed by the naked eye, as shown in FIGS. 3A and 3B. FIG. 3A is a photograph of the substrate obtained using the conventional method (A) and shows overlapping visibility on the surface of the substrate. In contrast, FIG. 3B is a photograph of the substrate obtained using the method disclosed herein (B) and shows minimal overlapping visibility on the surface of the substrate. This result indicates that the method of this disclosure can be used to improve surface defects without the need for reformulation of coating materials.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for minimizing overlap visibility in drop-on-demand coating applications, said method comprising the steps of:
a. applying at least two overlapping swaths (210) of a coating material (130) onto a surface (145) of a substrate (140) to achieve a target dry film thickness wherein each swath (210) has an edge (230);
b. creating a density gradient along the edge (230) of at least one swath (210) to generate a transition zone (220), wherein a width (W3) of the transition zone (220) is proportionally adjusted based on the target dry film thickness to soften a visible transition between overlapping swaths (210); and
c. controlling a slope (400) of the transition zone (220) to a value of less than about 0.45 microns per millimeter, calculated by dividing a height (H) of the transition zone (220) by the width (W3) of the transition zone (220), to minimize overlap visibility.

2. The method of claim 1 wherein the step of creating the density gradient is further defined as the step of creating a gradient of film thickness.

3. The method of claim 1 wherein the step of creating the density gradient is further defined as the step of creating a gradient of drops of the coating material (130) measured per inch of the surface (145) of the substrate (140).

4. The method of claim 1 wherein the step of creating the density gradient is further defined as:
a. obtaining image data and the target dry film thickness;
b. determining a variation from the target dry film thickness at one or more points of the transition zone (220); and
c. forming compensated image data to compensate for the variation, thereby creating the density gradient.

5. The method of claim 1 further comprising the step of adjusting the width (W3) of the transition zone (220).

6. The method of claim 1 wherein the step of applying is further defined as random dot printing.

7. The method of claim 1 wherein the width (W3) of the transition zone (220) is equal to or less than about 50% of the width (W3) of the swath (210).

8. The method of claim 1 wherein the target dry film thickness is from about 1 to about 100 microns.

9. The method of claim 1 wherein the coating material (130) is a solvent-borne coating composition.

10. The method of claim 1 wherein the coating material (130) is a waterborne coating composition.

11. The method of claim 1 wherein the slope (400) is from about 0.1 to about 0.45 microns per millimeter.

12. The method of claim 1 wherein the slope (400) is from about 0.2 to about 0.4 microns per millimeter.

13. The method of claim 1 wherein the step of applying is further defined as the step of applying two overlapping swaths (210) and the step of creating is further defined as creating a density gradient along the edge (230) of each of the two overlapping swaths (210) to generate two transition zones (220) such that the two transition zones (220) overlap and have the slopes (400) that are the same in numerical value and opposite in sign, within a deviation of about 5%.

14. The method of claim 13 wherein the two transition zones (220) have at least 80% overlap by area.

15. The method of claim 1 wherein the substrate (140) comprises a metal, a polymer, glass, wood, or combinations thereof.

16. A method for minimizing overlap visibility in drop-on-demand coating applications, said method comprising the steps of:
a. applying two overlapping swaths of a coating material (130) onto a substrate to achieve a target dry film thickness of from about 1 to about 100 microns wherein each swath (210) has an edge (230);
b. creating a density gradient along the edge (230) of at least one swath (210) to generate a transition zone (220), wherein a width (W3) of the transition zone (220) is proportionally adjusted based on the target dry film thickness to soften a visible transition between overlapping swaths (210); and
c. controlling a slope (400) of the transition zone (220) to a value of less than about 0.45 microns per millimeter, calculated by dividing a height (H) of the transition zone (220) by the width (W3) of the transition zone (220), to minimize overlap visibility.

17. A method for minimizing overlap visibility in drop-on-demand coating applications, said method comprising the steps of:
a. applying one coat of two overlapping swaths (210) of a solvent-borne coating composition onto a substrate to achieve a target dry film thickness of from about 1 to about 100 microns wherein each swath (210) has an edge (230);
b. creating a density gradient along the edge (230) of at least one swath (210) to generate a transition zone (220), wherein a width (W3) of the transition zone (220) is proportionally adjusted based on the target dry film thickness to soften a visible transition between overlapping swaths (210); and
c. controlling a slope (400) of the transition zone (220) to a value of from about 0.2 to about 0.4 microns per millimeter, calculated by dividing a height (H) of the transition zone by the width (W3) of the transition zone (220), to minimize overlap visibility.
